(19) United States
(12) Patent Application Publication
(10) Pub. No.: US 2014/0357537 A1
(43) Pub. Date: Dec. 4, 2014

(54) Branched Emulsifier for High-Temperature Acidizing

(71) Applicant: Halliburton Energy Services, Inc., Houston, TX (US)

(72) Inventors: Sushant Dattaram Wadekar, Mumbai (IN); Vikrant Bhavanishankar Wagle, Mumbai (IN); Nisha Arvind Pandya, Pune (IN)

(21) Appl. No.: 13/905,286

(22) Filed: May 30, 2013

(51) Int. Cl. C09K 8/72

(52) U.S. Cl. CPC C09K 8/72; C09K 2208/32
USPC 507/240

(57) ABSTRACT

A composition in the form of an emulsion is provided, the composition including: (i) a continuous oil phase; (ii) an internal aqueous acid phase adjacent the continuous oil phase; and (iii) a source of ammonium ion, wherein the ammonium ion has: (a) at least one ammonium ion; (b) an organic group with at least 40 carbon atoms; (c) at least 40 carbon atoms per ammonium ion; (d) a carbon to nitrogen ratio of at least 20 carbon atoms per nitrogen atom; and (e) at least one alkyl branch on the organic group. In addition, a method of acidizing a subterranean formation is provided, the method including the steps of: (A) forming a treatment fluid comprising a composition according to the invention; and (B) introducing the treatment fluid into the well.

### CROSS-REFERENCE TO RELATED APPLICATIONS

Not applicable.

### TECHNICAL FIELD

The inventions are in the field of producing crude oil or natural gas from subterranean formations. More specifically, the inventions generally relate to acid emulsions and methods of acidizing a subterranean formation, especially with very strong acids at high temperatures.

### BACKGROUND

The worldwide demand for hydrocarbons is expected to grow. As a result, explorations are turning to deeper reservoirs.

To produce oil or gas, a well is drilled into a subterranean formation that is an oil or gas reservoir.

Drilling, completion, and intervention operations can include various types of treatments that are commonly performed in a wellbore or subterranean formation.

For example, a treatment for fluid-loss control can be used during any of drilling, completion, and intervention operations. During completion or intervention, stimulation is a type of treatment performed to enhance or restore the productivity of oil and gas from a well. Stimulation treatments fall into two main groups: hydraulic fracturing and matrix treatments. Hydraulic fracturing treatments are performed above the fracture pressure of the subterranean formation to create or extend a highly permeable flow path between the formation and the wellbore. Matrix treatments are performed below the fracture pressure of the formation. Other types of completion or intervention treatments include, but are not limited to, formation isolation, wellbore cleanout, scale removal, and scale control. Of course, other well treatments and treatment fluids are known in the art.

### Acidizing

The purpose of acidizing is to dissolve acid-soluble materials. A treatment fluid including an aqueous acid solution is introduced into a subterranean formation to dissolve the acid-soluble materials. In this way, oil or gas can more easily flow from the formation into the well. In addition, an acid treatment can facilitate the flow of injected treatment fluids from the well into the formation.

Acidizing techniques can be carried out as acid fracturing procedures or matrix acidizing procedures.

In acid fracturing, an acidizing fluid is pumped into a formation at a sufficient pressure to cause fracturing of the formation and to create differential (non-uniform) etching of fracture conductivity. Depending on the rock of the formation, the acidizing fluid can etch the fractures faces, whereby flow channels are formed when the fractures close. The acidizing fluid can also enlarge the pore spaces in the fracture faces and in the formation.

In matrix acidizing, an acidizing fluid is injected from the well into the formation at a rate and pressure below the break-down pressure of the formation.

### Acidizing Sandstone or Carbonate Formations

Acidizing is commonly performed in sandstone and carbonate formations, however, the different types of formations can require that the particular treatments fluids and associated methods be quite different.

For example, sandstone formations tend to be relatively uniform in composition and matrix permeability. In sandstone, a range of stimulation techniques can be applied with a high degree of confidence to create conductive flow paths, primarily with hydraulic fracturing techniques, as known in the field.

In sandstone formations, acidizing primarily removes or dissolves acid soluble damage in the near-wellbore region. Therefore, in sandstone formations acidizing is classically considered a damage removal technique and not a stimulation technique. An exception is with the use of specialized hydrofluoric acid compositions, which can dissolve the siliceous material of sandstone.

Carbonate formations tend to have complex porosity and permeability variations with irregular fluid flow paths. Although many of the treatment methods for sandstone formations can also be applied in carbonate formations, it can be difficult to predict effectiveness for increasing production in carbonate formations.

In carbonate formations, the goal is usually to have the acid dissolve the carbonate rock to form highly-conductive fluid flow channels in the formation rock. These highly-conductive channels are called wormholes. In acidizing a carbonate formation, calcium and magnesium carbonates of the rock can be dissolved with acid. A reaction between an acid and the minerals calcite (CaCO₃) or dolomite (CaMg(CO₃)₂) can enhance the fluid flow properties of the rock.

In carbonate reservoirs, hydrochloric acid (HCl) is the most commonly applied stimulation fluid. Organic acids such as formic or acetic acid are used mainly in high-temperature applications. Stimulation of carbonate formations usually does not involve hydrofluoric acid, however, which is difficult to handle and commonly only used where necessary, such as in acidizing sandstone formations.

Greater details, methodology, and exceptions regarding acidizing can be found, for example, in “Production Enhancement with Acid Stimulation” 2^{nd} edition by Leonard Kalfayan (PennWell 2008), SPE 129329, SPE 123869, SPE 121464, SPE 121803, SPE 121008, IPTC 10693, and the references contained therein.

Problems with Acid Fracturing

When the acid is injected above the fracture pressure of the formation being treated, the treatment is called acid fracturing or fracture acidizing. The object is to create a large fracture that serves as an improved flowpath through the rock formation. After such fractures are created, when pumping of the fracture fluid is stopped and the injection pressure drops, the fracture tends to close upon itself and little or no new flow path is left open after the treatment. Commonly, a proppant is added to the fracturing fluid so that, when the fracture closes, proppant remains in the fracture, holds the fracture faces apart, and leaves a flow path conductive to fluids. In addition to or alternatively to propping, an acid may be used as a component of the fracturing fluid. Depending on the rock of the formation, the acid can differentially etch the faces of the fracture, creating or exaggerating asperities, so that, when the fracture closes, the opposing faces no longer match up. Consequently they leave an open pathway for fluid flow.

A problem with this technique is that as the acid is injected it tends to react with the most reactive rock or the rock with which it first comes into contact. Therefore, much of the acid is used up near the wellbore and is not available for etching of the fracture faces farther from the wellbore.

In addition, the acidic fluid follows the paths of least resistance, which are for example either natural fractures in the rock or areas of more permeable or more acid-soluble rock. Depending on the nature of the rock formation, this process can create long branched passageways in the fracture faces leading away from the fracture, usually near the wellbore. These highly conductive micro-channels are called “wormholes.” and can be very deleterious in fracturing because subsequently-injected fracturing fluid tends to leak off into the wormholes rather than lengthening the desired fracture. To block the wormholes, techniques called “leak-off control” techniques have been developed. This blockage should be temporary, however, because the wormholes are preferably open to flow after the fracturing treatment; oils or gas production through the wormholes adds to total production.

Problems with Matrix Acidizing

When an acidic fluid is used to stimulate a substantially acid-soluble formation below the fracturing pressure, the treatment is called matrix acidizing. Studies have shown that the dissolution pattern created by the flowing acid occurs by one of three mechanisms (a) compact dissolution, in which most of the acid is spent near the wellbore rock face; (b) wormholing, in which the dissolution advances more rapidly at the tips of a small number of wormholes than at the wellbore walls; and (c) uniform dissolution, in which many pores are enlarged. Compact dissolution occurs when acid spends on the face of the formation. In this case, the live acid penetration is commonly limited to within a few centimeters of the wellbore. Wormholes are usually formed when acid is pushed to tip of the hole for the reaction either by injecting acid at very high rate or decreasing the diffusion rate of the acid in the fluid. This is a preferred dissolution pattern in matrix acidizing since it creates a conductive channels for the flow of oils and subsequently injected fluids as well. Uniform dissolution occurs when the acid reacts under the laws of fluid flow through porous media. In this case, the live acid penetration will be, at most, equal to the volumetric penetration of the injected acid. (Uniform dissolution is also the preferred primary mechanism of conductive channel etching of the fracture faces in acid fracturing, as discussed above.) The objectives of the matrix acidizing process are met most efficiently when near wellbore permeability is enhanced to the greatest depth with the smallest volume of acid. This occurs in regime (b) above, when a wormholing pattern develops.

However, just as wormholing prevents the growth of large fractures, wormholing prevents the uniform treatment of long zones of a formation along a wellbore. Once wormholes have formed, at or near a point in the soluble formation where the acid first contacts the formation, subsequently-injected acid will tend to extend the existing wormholes rather than create new wormholes further along the formation. Temporary blockage of the first wormholes is needed so that new wormholes can be formed and the entire section of the formation treated. This is called “diversion,” as the treatment diverts later-injected acid away from the pathway followed by earlier-injected acid. In this case, the blockage must be temporary because all the wormholes are desired to serve as production pathways.

Corrosion Problems with Using Acids in Well Fluids

Although acidizing a portion of a subterranean formation can be very beneficial in terms of permeability, the use of acidizing fluids can have significant drawbacks. Even weakly acidic fluids can be problematic in that they can cause corrosion of metals. Corrosion can occur anywhere in a well production system or pipeline system, including anywhere downhole in a well or in surface lines and equipment.

The expense of repairing or replacing corrosion-damaged equipment is extremely high. The corrosion problem is exacerbated by the elevated temperatures encountered in deeper formations. The partial neutralization of the acid from undesired corrosion reactions can result in the production of quantities of metal ions that are highly undesirable in the subterranean formation.

### Acid in Oil Emulsions

Historically, acid emulsified in oil has primarily been used in fracture acidizing. The emulsified state of the acid makes it diffuse at much slower rate, thereby retarding the chemical reaction rate with the formation.

In addition, acid internal emulsions can be used to help separate the acid from the tubulars, but high concentrations of hydrochloric acid, a commonly used acid for acidizing, can be difficult to stabilize in an emulsion. A breaking of the emulsion before the targeted time and location in the well can cause severe corrosion of tubulars and downhole equipment. However, the stability of the emulsion becomes questionable as the fluid experiences high temperature of the formation (that is, equal to or greater than 280° F. (138° C.)).

Even with an acid-internal emulsion, the corrosion inhibition for the tubulars of the well while pumping the acidizing fluid down hole to the treatment zone of a subterranean formation is always an issue. In addition, the higher the temperature in the tubulars of the well and the higher the design temperature in the treatment zone of the subterranean formation, the greater the rate of corrosion, which increases the rate of damage to the tubulars.

Therefore, among other needs, there is a need for acidizing treatment fluids and methods with acids for stimulation of subterranean formations at high temperatures (that is, greater than 280° F. (138° C.)) while offering a minimum standard of protection against corrosion.

### SUMMARY OF THE INVENTION

According to an embodiment of the invention, a composition in the form of an emulsion is provided, the composition including: (i) a continuous oil phase; (ii) an internal aqueous acid phase adjacent the continuous oil phase; and (iii) a source of ammonium ion, wherein the ammonium ion has: (a) at least one ammonium ion; (b) an organic group with at least 40 carbon atoms; (c) at least 40 carbon atoms per ammonium ion; (d) a carbon to nitrogen ratio of at least 20 carbon atoms per nitrogen atom; and (e) at least one alkyl branch on the organic group.

According to another embodiment of the invention, a method of acidizing a treatment zone of a subterranean formation penetrated by a wellbore of a well is provided. The method includes the steps of: (A) forming a treatment fluid comprising a composition according to the invention; and (B) introducing the treatment fluid into the well, wherein the design temperature is at least 280° F. (138° C.).

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS

### Definitions and Usages

General Interpretation

The words or terms used herein have their plain, ordinary meaning in the field of this disclosure, except to the extent explicitly and clearly defined in this disclosure.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Oil and Gas Reservoirs

In the context of production from a well, oil and gas are understood to refer to crude oil and natural gas. Oil and gas are naturally occurring hydrocarbons in certain subterranean formations.

A “subterranean formation” is a body of rock that has sufficiently distinctive characteristics and is sufficiently continuous for geologists to describe, map, and name it. A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

Carbonate, Sandstone, and Other Formations

Reservoirs can be of various rock materials.

As used herein, a subterranean formation having greater than about 50% by weight of inorganic carbonate materials (for example, limestone or dolomite) is referred to as a “carbonate formation.”

As used herein, a subterranean formation having greater than about 50% by weight of inorganic silicatious materials (for example, sandstone) is referred to as a “sandstone formation.”

Well Terms

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well. The “borehole” usually refers to the inside wellbore wall, that is, the rock face or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

As used herein, introducing “into a well” means introduced at least into and through the wellhead. According to various techniques known in the art, tubulars, equipment, tools, or well fluids can be directed from the wellhead into any desired portion of the wellbore.

As used herein, the word “tubular” means any kind of body in the form of a tube. Examples of tubulars include, but are not limited to, a drill pipe, a casing, a tubing string, a line pipe, and a transportation pipe. Tubulars can also be used to transport fluids into or out of a subterranean formation, such as oil, gas, water, liquefied methane, coolants, and heated fluids. For example, a tubular can be placed underground to transport produced hydrocarbons or water from a subterranean formation to another location. Tubulars can be of any suitable body material, but in the oilfield are most commonly of steel.

Generally, well services include a wide variety of operations that may be performed in oil, gas, geothermal, or water wells, such as drilling, cementing, completion, and intervention. These well services are designed to facilitate or enhance the production of desirable fluids such as oil or gas from or through a subterranean formation.

A well service usually involves introducing a well fluid into a well. As used herein, a “well fluid” broadly refers to any fluid adapted to be introduced into a well for any purpose. A well fluid can be, for example, a drilling fluid, a cementing composition, a treatment fluid, or a spacer fluid. If a well fluid is to be used in a relatively small volume, for example less than about 200 barrels (32 m³), it is sometimes referred to as a wash, dump, slug, or pill.

As used herein, the word “treatment” refers to any treatment for changing a condition of a portion of a wellbore or an adjacent subterranean formation; however, the word “treatment” does not necessarily imply any particular treatment purpose. A treatment usually involves introducing a well fluid for the treatment, in which case it may be referred to as a treatment fluid, into a well. As used herein, a “treatment fluid” is a fluid used in a treatment. Unless the context otherwise requires, the word “treatment” in the term “treatment fluid” does not necessarily imply any particular treatment or action by the fluid.

The use of the term “acidizing” herein refers to the general process of introducing an acidic solution having a pH less than about 4 down hole to perform a desired function, for example, to acidize a portion of a subterranean formation or any damage contained therein. Acidizing can include matrix and fracturing types of acidizing treatments.

A zone refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a well fluid is directed to flow from the wellbore. As used herein, “into a treatment zone” means into and through the wellhead and, additionally, through the wellbore and into the treatment zone.

The term “damage” as used herein refers to undesirable deposits in a subterranean formation that may reduce its permeability. Scale, skin, gel residue, and hydrates are contemplated by this term. Also contemplated by this term are geological deposits, such as, but not limited to, carbonates located on the pore throats of the sandstone in a subterranean formation.

As used herein, a downhole fluid is an in-situ fluid in a well, which may be the same as a well fluid at the time it is introduced, or a well fluid mixed with another other fluid downhole, or a fluid in which chemical reactions are occurring or have occurred in-situ downhole.

Generally, the greater the depth of the formation, the higher are the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular well fluid or stage of a well service. A well service may include design parameters such as fluid volume to be pumped, required pumping time for a treatment, or the shear conditions of the pumping.

For example, the term “design temperature” refers to an estimate or measurement of the actual temperature at the downhole environment at the time of a well treatment. That is, design temperature takes into account not only the bottom hole static temperature (“BHST”), but also the effect of the temperature of the well fluid on the BHST during treatment. The design temperature is sometimes referred to as the bottom hole circulation temperature (“BHCT”). Because treatment fluids may be considerably cooler than BHST, the difference between the two temperatures can be quite large. Ultimately, if left undisturbed, a subterranean formation will return to the BHST.

Physical States and Phases

As used herein, “phase” is used to refer to a substance having a chemical composition and physical state that is distinguishable from an adjacent phase of a substance having a different chemical composition or different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, unless the context otherwise requires, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers or a large drop on the scale of a few millimeters. A particle of a substance in a gas state is a single atom or molecule that is separated from other atoms or molecules such that intermolecular attractions have relatively little effect on their respective motions.

As used herein, “particulate” or “particulate material” refers to matter in the physical form of distinct particles in a solid or liquid state (which means such an association of a few atoms or molecules). A particulate is a grouping of particles based on common characteristics, including chemical composition and particle size range, particle size distribution, or median particle size. As used herein, a particulate is a grouping of particles having similar chemical composition and particle size ranges.

A particulate can be of solid or liquid particles.

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified in a number of different ways, including based on the size of the dispersed particles, the uniformity or lack of uniformity of the dispersion, and, if a fluid, whether or not precipitation occurs.

A dispersion is considered to be heterogeneous if the dispersed particles are not dissolved and are greater than about 1 nanometer in size. (For reference, the diameter of a molecule of toluene is about 1 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

Homogeneous Dispersions: Solutions and Solubility

A solution is a special type of homogeneous mixture. A solution is considered homogeneous: (a) because the ratio of solute to solvent is the same throughout the solution; and (b) because solute will never settle out of solution, even under powerful centrifugation, which is due to intermolecular attraction between the solvent and the solute. An aqueous solution, for example, saltwater, is a homogenous solution in which water is the solvent and salt is the solute.

One may also refer to the solvated state, in which a solute ion or molecule is complexed by solvent molecules. A chemical that is dissolved in solution is in a solvated state. The solvated state is distinct from dissolution and solubility. Dissolution is a kinetic process, and is quantified by its rate. Solubility quantifies the concentration of the solute at which there is dynamic equilibrium between the rate of dissolution and the rate of precipitation of the solute. Dissolution and solubility can be dependent on temperature and pressure, and may be dependent on other factors, such as salinity or pH of an aqueous phase.

A substance is considered to be “soluble” in a liquid if at least 10 grams of the substance can be dissolved in one liter of the liquid (which is at least 83 ppt) when tested at 77° F. and 1 atmosphere pressure for 2 hours, considered to be “insoluble” if less than 1 gram per liter (which is less than 8.3 ppt), and considered to be “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

The “source” of a chemical species in a solution or fluid composition, can be a substance that is or makes the chemical species chemically available immediately or it can be a substance that gradually or later releases or forms the chemical species to become chemically available.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, for example, a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of Intermolecular Forces.)

As used herein, a fluid is a substance that behaves as a fluid under Standard Laboratory Conditions, that is, at 77° F. (25° C.) temperature and 1 atmosphere pressure, and at the higher temperatures and pressures usually occurring in subterranean formations without applied shear.

Every fluid inherently has at least a continuous phase. A fluid can have more than one phase. The continuous phase of a well fluid is a liquid under Standard Laboratory Conditions. For example, a well fluid can in the form of be a suspension (solid particles dispersed in a liquid phase), an emulsion (liquid particles dispersed in another liquid phase), or a foam (a gas phase dispersed in liquid phase).

As used herein, a water-based fluid means that water or an aqueous solution is the dominant material, that is, greater than 50% by weight, of the continuous phase of the substance.

In contrast, “oil-based” means that oil is the dominant material by weight of the continuous phase of the substance. In this context, the oil of an oil-based fluid can be any oil. In general, an oil is any substance that is liquid at Standard Laboratory Conditions, is hydrophobic, i.e. immiscible with water. Oils have a high carbon and hydrogen content and are relatively non-polar substances, for example, having a polarity of 3 or less on the Synder polarity index. This general definition includes classes such as petrochemical oils, vegetable oils, and many organic solvents. All oils can be traced back to organic sources.

General Measurement Terms

Unless otherwise specified or unless the context otherwise clearly requires, any ratio or percentage means by weight (w/w).

Unless otherwise specified or unless the context otherwise clearly requires, the phrase “by weight of the water” means the weight of the water of the aqueous phase of the fluid without the weight of any viscosity-increasing agent, dissolved salt, suspended particulate, or other materials or additives that may be present in the water.

Any doubt regarding whether units are in U.S. or Imperial units, where there is any difference, U.S. units are intended. For example, “gpt” or “gal/Mgal” means U.S. gallons per thousand U.S. gallons and “ppt” means pounds per thousand U.S. gallons. (For convenient comparisons, 1 ppt is equivalent to 0.12 grams/liter.)

The conversion between lb/Mgal and kg/m³ is: 1 lb/Mgal=(0.453592 kg/lb)×(Mgal/3.78541 m³)=0.12 kg/m³.

Acid Corrosion of Steel

Corrosion of metals can occur anywhere in an oil or gas production system, such in the downhole tubulars, equipment, and tools of a well, in surface lines and equipment, or transportation pipelines and equipment.

“Corrosion” is the loss of metal due to chemical or electrochemical reactions, which could eventually destroy a structure. The corrosion rate will vary with time depending on the particular conditions to which a metal is exposed, such as the amount of water, pH, other chemicals, temperature, and pressure. Examples of common types of corrosion include, but are not limited to, the rusting of metal, the dissolution of a metal in an acidic solution, oxidation of a metal, chemical attack of a metal, electrochemical attack of a metal, and patina development on the surface of a metal.

As used herein with reference to the problem of corrosion, “acid” or “acidity” refers to a Bronsted-Lowry acid or acidity. Even weakly acidic fluids can be problematic in that they can cause corrosion of metals.

Mineral Acids and Organic Acids

Strongly acidic solutions tend to be more corrosive to metals, and steel in particular.

The pH value represents the acidity of a solution. The potential of hydrogen (pH) is defined as the negative logarithm of the hydrogen concentration, represented as [H⁺] in moles/liter.

Mineral acids tend to dissociate in water more easily than organic acids, to produce H⁺ ions and decrease the pH of the solution. Organic acids tend to dissociate more slowly than mineral acids and less completely.

Relative acid strengths for Bronsted-Lowry acids are expressed by the dissociation constant (pKa). A given acid will give up its proton to the base of an acid with a higher pKa value. The bases of a given acid will deprotonate an acid with a lower pKa value. In case there is more than one acid functionality for a chemical, “pKa(1)” makes it clear that the dissociation constant relates to the first dissociation.

Water (H₂O) is the base of the hydronium ion, H₃O⁺, which has a pKa −1.74. An acid having a pKa less than that of hydronium ion, pKa −1.74, is considered a strong acid.

For example, hydrochloric acid (HCl) has a pKa −7, which is greater than the pKa of the hydronium ion, pKa −1.74. This means that HCl will give up its protons to water essentially completely to form the H₃O⁺ cation. For this reason, HCl is classified as a strong acid in water. One can assume that all of the HCl in a water solution is 100% dissociated, meaning that both the hydronium ion concentration and the chloride ion concentration correspond directly to the amount of added HCl.

Acetic acid (CH₃CO₂H) has a pKa of 4.75, greater than that of the hydronium ion, but less than that of water itself, 15.74. This means that acetic acid can dissociate in water, but only to a small extent. Therefore, acetic acid is classified as a weak acid.

Acid Corrosion of Metals

As mineral acids are stronger acids than organic acids, mineral acids tend to be more corrosive than organic acids. In addition, at elevated temperatures the dissociation rate for a weak acid increases significantly, and hence, all else being equal, a weak acid becomes more corrosive. Moreover, as a chemical reaction, rate of corrosion increases with increasing temperature for both strong and weak acids.

The mechanism of corrosion for both cases (mineral acids and organic acids) is expected to be same, the only difference is in the rate of corrosion. The rate of corrosion will depend upon the availability of H⁺ ion released from acid. Mineral acids dissociate completely to give more H⁺ ions as compared to organic acids.

Iron and Steel Corrosion

Iron is a chemical element with the symbol Fe (from Latin: ferrum) and atomic number 26. It is a metal in the first transition series. It is the most common element (by mass) forming the planet Earth as a whole, forming much of Earth's outer and inner core. It is the fourth most common element in the Earth's crust. Iron exists in a wide range of oxidation states, −2 to +8, although +2 and +3 are the most common. Elemental iron is reactive to oxygen and water. Fresh iron surfaces appear lustrous silvery-gray, but oxidize in normal air to give iron oxides, also known as rust. Unlike many other metals which form passivating oxide layers, iron oxides occupy more volume than iron metal, and so iron oxides flake off and expose fresh surfaces for corrosion.

Pure iron is softer than aluminum, but iron is significantly hardened and strengthened by impurities from the smelting process, such as carbon. A certain proportion of carbon (between 0.2% and 2.1%) produces steel, which may be up to 1,000 times harder than pure iron. Crude iron metal is produced in blast furnaces, where ore is reduced by coke to pig iron, which has high carbon content. Further refinement with oxygen reduces the carbon content to the correct proportion to make steel.

Carbon steel is steel where the main interstitial alloying constituent is carbon. As the carbon content rises, steel has the ability to become harder and stronger through heat treating, but this also makes it less ductile. Regardless of the heat treatment, higher carbon content reduces weldability. In carbon steels, the higher carbon content lowers the melting point. The typical composition of carbon steel is an alloy of iron containing no more than 2.0 wt % of carbon.

The term “carbon steel” may also be used in reference to steel which is not stainless steel; in this use carbon steel may include alloy steels.

The American Iron and Steel Institute (AISI) defines carbon steel as the following: “Steel is considered to be carbon steel when no minimum content is specified or required for chromium, cobalt, molybdenum, nickel, niobium, titanium, tungsten, vanadium or zirconium, or any other element to be added to obtain a desired alloying effect; when the specified minimum for copper does not exceed 1.04 percent; or when the maximum content specified for any of the following elements does not exceed the percentages noted: manganese 1.65, silicon 0.60, copper 0.60.”

Generally speaking, carbon steels contain up to 2% total alloying elements and can be subdivided into low-carbon steels, medium-carbon steels, high-carbon steels, and ultrahigh-carbon steels. Low-carbon steels contain up to 0.30% C. Medium-carbon steels are similar to low-carbon steels except that the carbon ranges from 0.30 to 0.60% and the manganese from 0.60 to 1.65%. Ultrahigh-carbon steels are experimental alloys containing 1.25 to 2.0% C.

Steels and low carbon iron alloys with other metals (alloy steels) are by far the most common metals in industrial use, due to their great range of desirable properties and the abundance of iron. Steel is commonly used in oilfield and pipeline tubular and equipment.

For example, carbon steel is usually used in tubes for the production of oil, for example “N-80”, “J-55”, or “P-110,” having the following typical composition ranges, by weight: 0.20% to 0.45% C; 0.15% to 0.40% Si; 0.60% to 1.60% Mn; 0.03% maximum S; 0.03% maximum P; 1.60% maximum Cr; 0.50% maximum Ni; 0.70% maximum No; 0.25% maximum Cu; and balance Fe (greater than 94%).

Without being limited by any theory, it is believed the corrosion of steel is attributable to the reactivity of iron (Fe).

In the range of pH about 4 to about 10, the corrosion rate of iron or steel is relatively independent of the pH of the solution. In this pH range, the corrosion rate is governed largely by the rate at which oxygen reacts with absorbed atomic hydrogen, thereby depolarizing the surface and allowing the reduction reaction to continue.

For acidic pH values below 4, ferrous oxide (FeO) is soluble. Therefore, the oxide dissolves as it is formed rather than depositing on the metal surface to form a film. In the absence of the protective oxide film, the metal surface is in direct contact with the acid solution, and the corrosion reaction proceeds at a greater rate than it does at higher pH values. It is also observed that hydrogen is produced in acid solutions below a pH of about 4, indicating that the corrosion rate no longer depends entirely on depolarization by oxygen, but on a combination of the two factors (hydrogen evolution and depolarization).

For pH values above about 10, the corrosion rate is observed to fall as pH is increased. This is believed to be due to an increase in the rate of the reaction of oxygen with Fe(OH)₂ (hydrated FeO) in the oxide layer to form the more protective Fe₂O₃ (note that this effect is not observed in deaerated water at high temperatures).

As used herein, the term “carbon steel” does not include stainless steel. Stainless steel differs from carbon steel by amount of chromium present.

In metallurgy, stainless steel, also known as inox steel or inox from French “inoxydable,” is defined as a steel alloy with a minimum of 11.5% chromium content by weight. Stainless steel does not corrode, rust, or stain with water as ordinary steel does, but despite the name it is not fully stain-proof, most notably under low oxygen, high salinity, or poor circulation environments. It is also called corrosion-resistant steel or CRES when the alloy type and grade are not detailed. There are different grades and surface finishes of stainless steel to suit the intended environment. Stainless steel is used where both the properties of steel and resistance to corrosion are required.

Stainless steel differs from carbon steel by the amount of chromium present. Unprotected carbon steel rusts readily when exposed to air and moisture. This iron oxide film (the rust) is active and accelerates corrosion by forming more iron oxide, and due to the dissimilar size of the iron and iron oxide molecules (iron oxide is larger) these tend to flake and fall away. Stainless steels contain sufficient chromium to form a passive film of chromium oxide, which prevents further surface corrosion and blocks corrosion from spreading into the internal material of the metal, and due to the similar size of the steel and oxide molecules they bond very strongly and remain attached to the surface. Passivation only occurs if the proportion of chromium is high enough and in the presence of oxygen.

### Invert Emulsion of Strong Acid to Reduce Corrosion

There is a strong demand for emulsified acids, especially concentrated HCl acid with acid concentration of about 20% or greater, for example, in the range of about 20% to about 28%. In addition, achieving acceptable corrosion loss of less than about 0.05 lb/ft² and a stable emulsion for the desired treatment time is crucial for a successful emulsified acid blend.

To help physically separate the acid from metals in the well, such as the tubulars, a composition can be in the form of an invent emulsion, that is, a water-in-oil emulsion. The water with the acid is carried into the well and through the tubulars to the treatment zone as the internal phase of an external oil phase.

In addition, a chemical corrosion inhibitor and corrosion inhibitor intensifier can be included to help reduce the corrosion of the metal goods in the well. This is especially desirable at high temperatures because the rate of corrosion caused by acid increases with increasing temperature.

### Emulsions

In general, an emulsion is a fluid including a dispersion of immiscible liquid particles in an external liquid phase. In addition, the proportion of the external and internal phases is above the solubility of either in the other.

An emulsion can be an oil-in-water (o/w) type or water-in-oil (w/o) type. A water-in-oil emulsion is sometimes referred to as an invert emulsion. In the context of an emulsion, a “water phase” refers to a phase of water or an aqueous solution and an “oil phase” refers to a phase of any non-polar organic liquid that is immiscible with water, such as petroleum, kerosene, or synthetic oil.

It should be understood that multiple emulsions are possible. These are sometimes referred to as nested emulsions. Multiple emulsions are complex polydispersed systems where both oil-in-water and water-in-oil emulsions exist simultaneously in the fluid, wherein the oil-in-water emulsion is stabilized by a lipophilic surfactant and the water-in-oil emulsion is stabilized by a hydrophilic surfactant. These include water-in-oil-in-water (w/o/w) and oil-in-water-in-oil (o/w/o) type multiple emulsions. Even more complex polydispersed systems are possible. Multiple emulsions can be formed, for example, by dispersing a water-in-oil emulsion in water or an aqueous solution, or by dispersing an oil-in-water emulsion in oil.

A stable emulsion is an emulsion that will not cream, flocculate, or coalesce under certain conditions, including time and temperature. As used herein, the term “cream” means at least some of the droplets of a dispersed phase converge towards the surface or bottom of the emulsion (depending on the relative densities of the liquids making up the continuous and dispersed phases). The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

Preferably, an emulsion should be stable under one or more of certain conditions commonly encountered in the storage and use of such an emulsion composition for a well treatment operation. It should be understood that the dispersion is visually examined for creaming, flocculating, or coalescing.

Preferably, an emulsion should be stable for a minimum desired duration in a well under the design conditions of a treatment.

As used herein, to “break,” in regard to an emulsion, means to cause the creaming and coalescence of emulsified drops of the internal dispersed phase so that the internal phase separates out of the external phase. Breaking an emulsion can be accomplished mechanically (for example, in settlers, cyclones, or centrifuges), or via dilution, or with chemical additive that destabilizes the stable interphase between two phases of the emulsion causing the separation of the two phases.

### External Oil Phase

The oil phase includes a natural or synthetic source of an oil. Examples of oils from natural sources include, without limitation, kerosene, diesel oils, crude oils, gas oils, fuel oils, paraffin oils, mineral oils, low toxicity mineral oils, other petroleum distillates, and any combination thereof. Examples of synthetic oils include, without limitation, polyolefins, polydiorganosiloxanes, siloxanes, organosiloxanes.

In an embodiment, the external phase is the continuous phase of a well fluid. The external oil phase has a viscosity of less than 200 cP. Preferably, the external oil phase has a viscosity of less than 20 cP.

In an embodiment, the external phase has less than a sufficient concentration of any polyvalent metal salt therein to gel the external phase. For example, the external phase is not gelled with a polyvalent metal salt of an organophosphonic acid ester or a polyvalent metal salt of an organophosphinic acid. Preferably, the external phase is substantially free of any polyvalent metal salt compound.

### Internal Aqueous Acid Phase

According to the invention, the emulsion includes an aqueous acid phase adjacent to the external oil phase.

Preferably, the water for use in the treatment fluid does not contain anything that would adversely interact with the other components used in the well fluid or with the subterranean formation.

The aqueous phase can include freshwater or non-freshwater. Non-freshwater sources of water can include surface water ranging from brackish water to seawater, brine, returned water (sometimes referred to as flowback water) from the delivery of a well fluid into a well, unused well fluid, and produced water. As used herein, brine refers to water having at least 40,000 mg/L total dissolved solids.

In some embodiments, the aqueous phase of the treatment fluid may comprise a brine. The brine chosen should be compatible with the formation and should have a sufficient density to provide the appropriate degree of well control.

Salts may optionally be included in the treatment fluids for many purposes. For example, salts may be added to a water source, for example, to provide a brine, and a resulting treatment fluid, having a desired density. Salts may optionally be included for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid.

Suitable salts can include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The amount of salt that should be added should be the amount necessary for formation compatibility, such as stability of clay minerals, taking into consideration the crystallization temperature of the brine, for example, the temperature at which the salt precipitates from the brine as the temperature drops.

The water includes one or more acids that are sufficiently strong and in a sufficient concentration to cause the water to have a pH of less than zero. Preferably, the one or more acids are in a sufficient concentration to cause the water to have a pH of equal to or less than minus 0.5. For example, hydrochloric acid can be used. While other acids can be used, the strong acid preferably is or comprises hydrochloric acid. For example, sulfuric acid would produce undesirable sulfate ions after reaction with the formation rock or carbonate formation.

Hydrochloric acid is produced in solutions up to 38% HCl by weight of the water (concentrated grade). Higher concentrations up to just over 40% are chemically possible, but the evaporation rate is then so high that storage and handling need extra precautions, such as pressure and low temperature. Bulk industrial-grade is therefore 30% to 34%, optimized for effective transport and limited product loss by HCl vapors. Solutions for household purposes in the US, mostly cleaning, are typically 10% to 12%, with strong recommendations to dilute before use.

In a preferred embodiment according to the invention, the hydrochloric acid is in a concentration of at least 10% by weight of water of the internal aqueous phase. More preferably, the hydrochloric acid is in a concentration in the range of about 20% to about 28% by weight of water of the internal aqueous phase. In some embodiments, the hydrochloric acid is in a concentration of at least 25% by weight of the water of the internal aqueous phase.

### Invert Emulsion Ratio

In an embodiment, the ratio of water phase to oil phase is in the range of about 50:50 v/v to about 80:20 v/v

### Emulsifier

An emulsifier is a kind of surfactant. Surfactants are surface active compounds, that is, they show higher activity (i.e. concentration) at the surface or interface than the bulk solution phase. Due to this property, they lower the surface tension of a liquid, the interfacial tension between two liquids, or that between a liquid and a solid. Surfactants may act as detergents, wetting agents, emulsifiers, foaming agents, and dispersants.

Surfactants are usually organic compounds that are amphiphilic, meaning they contain both hydrophobic groups (“tails”) and hydrophilic groups (“heads”). Therefore, a surfactant contains both an oil soluble component and a water soluble component.

In a water phase, for example, surfactants form aggregates, such as micelles, where the hydrophobic tails form the core of the aggregate and the hydrophilic heads are in contact with the surrounding liquid. Other types of aggregates such as spherical or cylindrical micelles or bilayers can be formed. The shape of the aggregates depends on the chemical structure of the surfactants, depending on the balance of the sizes of the hydrophobic tail and hydrophilic head.

As used herein, the term micelle includes any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure. Micelles can function, among other purposes, to solubilize certain materials.

As used herein, an “emulsifier” refers to a type of surfactant that helps prevent the droplets of the dispersed phase of an emulsion from flocculating or coalescing in the emulsion. As used herein, an emulsifier refers to a chemical or mixture of chemicals that helps prevent the droplets of the dispersed phase of an emulsion from flocculating or coalescing in the emulsion.

An emulsifier can be or include a cationic, a zwitterionic, or a nonionic emulsifier. A surfactant package can include one or more different chemical surfactants.

### Emulsion Stability Factors

With increasing temperature, the dosage requirement of corrosion inhibitor or intensifier increases. One frequently experienced phenomenon, however, is that increasing the amount of corrosion inhibitors or intensifiers decreases the stability of emulsified acids, especially with high concentrations of strong acid in the internal water phase and at high temperatures. It has been a common observation that when an emulsion breaks during a corrosion test, the corrosion loss is high, far above 0.05 lb/ft². This is very simple to explain: since the metal is directly exposed to the inhibited acid phase after the destabilization of emulsion, it can be more directly attacked by the acid despite the presence of the inhibitor. Therefore, in addition to corrosion inhibition, stability of the emulsion is critical to obtaining an acceptable level of corrosion.

Without being limited by any theory, there are several theoretical bases for the lack of emulsion stability, ranging from the very different densities of the water and oil phases to chemical reactivity of a strong acid in the water phase. Among other factors and problems, it is believed that there is a problem with the compatibility of emulsifiers with chemical corrosion inhibitors or intensifiers, especially at higher temperatures. This can be a particular challenge at higher temperatures (greater than 280° F. (138° C.)) and with high concentrations of HCl acid, especially at about 20% or more.

For emulsified acid systems, the emulsion instability and corrosion rate are interrelated and both increase with increase in temperature. In addition, one or more corrosion inhibitors or intensifiers are also highly valuable components in any acid blend, and generally considered necessary components, but are considered to be the most damaging to the emulsifier performance as they are believed to contribute to destabilizing the emulsion.

### Emulsified Acid Systems and Methods According to the Invention

The present disclosure relates to emulsified acid systems, which can be used for acid stimulation in a well.

According to an embodiment of the invention, a composition in the form of an emulsion is provided, the composition including: (i) a continuous oil phase; (ii) an internal aqueous phase adjacent the continuous oil phase, wherein the aqueous phase has a pH of less than one; (iii) a source of ammonium ion, wherein the ammonium ion has: (a) at least one ammonium ion; (b) an organic group with at least 40 carbon atoms; (c) at least 40 carbon atoms per ammonium ion; (d) a carbon to nitrogen ratio of at least 20 carbon atoms per nitrogen atom; and (e) at least one alkyl branch on the organic group.

The emulsified acid systems and methods according to the invention can be used in any subterranean formation or at any design temperature in a well, however, they offer particulate advantage in stimulating high-temperature carbonate reservoirs with bottomhole temperatures greater than 280° F. (138° C.). The emulsified nature of the system enhances the corrosion inhibition, but the stability of the emulsified acid system is a major problem associated with high temperature applications greater than 280° F. (138° C.), especially with concentrated HCl acid strengths equal to or greater than about 20% HCl, which tend to become unstable above 280° F. (138° C.) and cause high corrosion loss.

In an embodiment, of the method or composition, the aqueous acid phase has a pH of less than one. Preferably, the aqueous acid phase can be a strongly acidic solution, for example, having about 20% to about 28% HCl acid strength.

According to an embodiment of the invention, the composition additional comprises a corrosion inhibitor. In an embodiment, the corrosion inhibitor is selected from the group consisting of: a quaternary ammonium salt with the nitrogen atom of the ammonium group attached to 4 carbons and being part of an aromatic ring (e.g., 1-(benzyl)quinolinium chloride), an aldehyde or an aldehyde precursor that contains conjugated double bonds in conjugation with aldehyde group (e.g., cinnamaldehyde), an acetylenic alcohol (e.g., propargyl alcohol), and any combination thereof.

According to an embodiment of the invention, the composition additional comprises a corrosion inhibitor intensifier selected from the group consisting of: a source of carboxylate ion selected from the group consisting of formic acid, oxalic acid, sodium formate, potassium formate, sodium oxalate, potassium oxalate, and any combination thereof; a source of iodide ion; and a source of cuprous ion; and any combination thereof. Without being limited by any theory, is believed that the source of carbon monoxide, the iodide ion, and the cuprous ion can function as corrosion inhibitor intensifiers. It should be understood that it is not necessary for the source of carboxylate ion to be completely dissociated in the aqueous phase.

In an embodiment, the source of iodide ion provides a concentration of iodide ion of at least 0.01 moles/liter in the aqueous phase and the source of cuprous ion provides a concentration of cuprous ion of at least 0.01 moles/liter in the aqueous phase. For example, this would be at least 0.01 moles/liter of potassium iodide (166 g/mole) in the aqueous phase, equivalent to at least 1.7 gram/liter of potassium iodide in the aqueous phase. Similarly, for example, this would be at least 0.01 moles/liter of cuprous chloride (99 g/mole) in the aqueous phase, equivalent to at least 1.0 gram/liter of cuprous chloride in the aqueous phase. (These concentrations are far in excess of the concentrations naturally occurring in water sources such as freshwater or seawater.)

According to another embodiment of the invention, a method of acidizing a treatment zone of a subterranean formation penetrated by a wellbore of a well is provided. The method includes the steps of: (A) forming a treatment fluid comprising a composition according to the invention; and (B) introducing the treatment fluid into the well. In an embodiment of the method, the design temperature is at least 280° F. (138° C.).

The invert emulsion fluid system is designed for efficient acid stimulation treatment of a subterranean formation. The emulsions according to the invention have particular applicability to acidizing high-temperature carbonate formations. The primary goal behind using emulsified acid is that it will react slowly with the carbonates compared to plain acid particularly at high temperatures. The more retarded release of the acid will allow use of acid system at much higher temperature as compared to other unretarded (that is, non-emulsified) acids or gelled acid systems).

An emulsified acid system according to the invention can perform better in reservoirs with design temperatures or SBHTs ranging from about 280° F. (138° C.) to about 375° F. (190° C.) as compared to other unretarded (that is, non-emulsified) acids or gelled acid systems. For example, the new emulsified acid system can work with 28% acid strength at a design temperature higher than 300° F. (149° C.). The use of new emulsifier gives good emulsion stability and acceptable corrosion loss at 325° F. (163° C.) for 3 hours with 28% HCl acid strength. The present system can be used for acid stimulation of carbonate reservoirs with BHSTs or design temperatures up to at least 350° F. (177° C.) for 2 hours while maintaining an acceptable standard of corrosion.

In addition, the branched emulsifier also has lower CSI (Chemistry Scoring Index) than a previously used emulsifier having temperature limit of only about 300° F. A Chemical Scoring Index (“CSI”) has been developed to help reduce various environmental concerns to a single score. See Society of Petroleum Engineers (“SPE”) 126451, Are your Chemical Products Green?—A Chemical Hazard Scoring System, Johnny Sanders, Denise Tuck, and Robert Sherman, Halliburton, 2010.

An important feature of an invert acid system according to the invention is that it can be used in acidizing treatment of high temperature carbonate reservoirs of up to at least 350° F. (177° C.) for 2 hours.

The system is expected to have particular application in carbonate formations at high BHST. The system will give better wormholing at high temperature and can be used with acid strength ranging 20% to 28% to provide enhanced oil production from the formation.

### Branched Emulsifier for High-Temperature

The emulsifier is a critical factor in the stability of an emulsified acid treatment fluid.

An example of a conventional emulsifier is a linear cationic amine selected from the group consisting of: a monotallow amine, a ditallow amine, an acetate salt of any of the foregoing, and any combination thereof. A monotallow amine has an alkyl chain length in the range of 16 to 20 carbon atoms. A ditallow amine has an alkyl chain length in the range of about 32 to 40 carbon atoms. The alkyl chains in such amines are straight with no branches. Ditallowamine acetate is a yellow solid. Ditallowamine acetate (“DTAA”) is considered to be the main component of the conventional emulsifier. Monotallowamine acetate (“MTAA”) is a more hydrophilic co-emulsifier. For example, a suitable conventional emulsifier package for temperatures up to about 275° F. (135° C.) is a composition of about 50% concentration of a mixture of monotallow amine acetates, C16-C18 (also known as CAS 61790-60-1) and ditallow amine acetates (also known as CAS 71011-03-5) in a suitable solvent such as a mixture of heavy aromatic naphtha and ethylene glycol.

It is believed that the structure of a surfactant to be used as emulsifier has great impact on the stability and overall performance of the emulsion system. The structure of surfactant can be modified based on the structure-performance relationship. Without being limited by any theory, it is presently believed that increasing the chain length of the surfactant increases the stability of the emulsion. In addition, the presence of alkyl branching in emulsifier is also known to increase the stability of the emulsion.

According to the invention, a new type of emulsifier is selected for use in a composition for acidizing in a well. The emulsifier is a source of ammonium ion, wherein the ammonium ion has: (a) at least one ammonium ion; (b) an organic group with at least 40 carbon atoms; (c) at least 40 carbon atoms per amine group; (d) a carbon to nitrogen ratio of at least 20 carbon atoms per nitrogen atom; and (e) at least one alkyl branch on the organic group.

Primary, secondary, tertiary, and quaternary amines and derivatives can be used as surfactants for forming emulsions. The primary amines are preferable, however, due to its better environmental rating. In addition, there may be differences in the chemical stability of primary, secondary, tertiary and quaternary amines in acid at higher temperatures. But the effect of type of amine will be less than the effect of chain length on the stability. Quaternary amines will also form stable emulsion but may not break after acid is spent in carbonate formation.

It should be understood that a free amine added to an acidic solution can form a ammonium ion.

Preferably, the ammonium ion has multiple alkyl branches. Most preferably, the multiple alkyl branches are methyl branches.

The source of the ammonium ion can be a polyamine, which can work as polymeric emulsifier. Preferably, the amine has less than 1,000 carbon atoms.

Preferably, the a source of ammonium ion has a chemical scoring index of less than 500. More preferably, the amine has a chemical scoring index of less than 300.

An example of a suitable amine for use according to the invention is KEROCOM™ PIBA 03, which is a mixture of polyisobutylene (25-35%) and its amine derivative (65-75%), commercially available from BASF AG, Ludwigshafen, Germany. Chemically, KEROCOM™ PIBA 03 is a polyisobutylene (PIB) with average molecular weight of approximately 1,000 g/mol, which has been further derivatised to corresponding amine to an extent of about 75% by weight and is supplied as a concentrate of about 65% by weight in aliphatic hydrocarbons. KEROCOM™ PIBA 03 is further described in U.S. Pat. No. 8,067,349, which is incorporated by reference in its entirety). This has conventionally been used in fuel additives a dispersant. It is believed that the polyisobuylene amine derivative is the active surfactant.

There are three important structural differences between PIBA and ditallowamine acetate (“DTAA”). The total number of carbon atoms in PIBA is about 71; whereas the total number of carbon atoms in ditallowamine acetate is in the range of 32-40. There are about 36 carbon atoms present as methyl branches of the total of about 71 carbon atoms, that is, PIBA is highly branched product as against the straight chain of ditallowamine acetate.

Regarding CSI score, the KEROCOM™ PIBA 03 is a primary amine, whereas the ditallow amine acetate is a secondary amine. Accordingly, the PIBA is expected to have an overall lower CSI score.

In addition, to counter the increasingly hydrophobic character of the surfactant due to increasing the chain length of one of the surfactants used as an emulsifier, it is preferred to include another surfactant as an emulsifier that is less hydrophobic. Examples of emulsifiers that may be less hydrophobic include other fatty amines and derivatives of fatty amines. The chain length of such emulsifiers can be anywhere between 10 to 22. Examples of such derivatives include ethoxylate, amide, etc. A presently preferred example of a less hydrophobic emulsifier than KEROCOM™ PIBA 03 is a monotallowamine or its salt. For example, the use of a branched emulsifier can be balanced with the inclusion in the treatment fluid of another emulsifier such as monotallowamine or monotallowamine acetate. This way, the overall characteristics of a surfactant package can be adjusted to be suitable for use as an emulsifier.

According to an embodiment of the invention, a new emulsifier composition is proposed for formulating the emulsified acid system. The new emulsifier composition comprises of KEROCOM™ PIBA 03 and a monotallowamine or its salts.

In addition, the emulsifier is preferably selected for being capable of stabilizing an emulsion with at least a 20% HCl acid as an internal aqueous phase, and for being chemically stable to such acid phase. In an embodiment, emulsifier is chemically stable in the presence of strong acid concentrations and design temperature and time for the use of the fluid.

The emulsifier is preferably in a concentration of at least 0.1% by weight of the emulsion. More preferably, the emulsifier is in a concentration in the range of 0.1% to 10% by weight of the emulsion.

Corrosion Inhibitor

As used herein, the term “inhibit” or “inhibitor” refers to slowing down or lessening the tendency of a phenomenon (for example, corrosion) to occur or the degree to which that phenomenon occurs. The term “inhibit” or “inhibitor” does not imply any particular mechanism, or degree of inhibition.

Examples of corrosion inhibitors include acetylenic alcohols, unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, derivatives of cinnamaldehyde, fluorinated surfactants, quaternary derivatives of halomethylated aromatic compounds, combinations of such compounds used in conjunction with iodine; quaternary ammonium compounds; and combinations thereof.

According to a preferred embodiment of the invention, the corrosion inhibitor is selected from the group consisting of: a quaternary ammonium salt with the nitrogen atom of the ammonium group attached to 4 carbons and being part of an aromatic ring (for example, 1-(benzyl)quinolinium chloride), an aldehyde or an aldehyde precursor that contains conjugated double bonds in conjugation with aldehyde group (for example, cinnamaldehyde), an acetylenic alcohol (e.g., propargyl alcohol), and any combination thereof.

When included, a corrosion inhibitor is preferably in a concentration of at least 0.1% by weight of the emulsion. More preferably, the corrosion inhibitor is in a concentration in the range of 0.1% to 15% by weight of the emulsion.

### Corrosion Inhibitor Intensifiers

A corrosion inhibitor “intensifier” is a chemical compound that itself does not inhibit corrosion, but enhances the effectiveness of a corrosion inhibitor over the effectiveness of the corrosion inhibitor without the corrosion inhibitor intensifier.

Without being limited by any theory, it is believed that certain carboxylate ions (for example, formate or oxalate ion), iodide ions, cuprous ions, and silica gel are corrosion inhibitor intensifiers.

Formic acid or oxalic acid, upon heating or in the presence of certain strong acids, are capable of generating carbon monoxide gas. It is believed that the carbon monoxide can act as a corrosion inhibitor intensifier. Primarily for cost reasons, however, formic acid is presently preferred. Formic acid is commercially available, usually as a 95% aqueous solution.

In a presently preferred embodiment, the source of carboxylate ion provides a concentration of carboxylate ion in the range of 0.05 mole/liter to 0.2 mole/liter in the aqueous phase of the emulsion.

Iodide ions can be used as an intensifier. A source of iodide ions can be, for example, a water-soluble or acid-soluble inorganic iodide salt can be used. In some cases desirable to avoid sodium ion, however, which can interfere with emulsion stability, whereas potassium iodide may also help stabilize emulsion at high temperature.

Without being limited by any theory, it is thought that halide ions are able to improve adsorption of the organic cations by forming the intermediate bridges between the positively charged metal surface and the positive end of a corrosion inhibitor. Corrosion inhibition results from increased surface coverage arising from ion-pair interactions between the organic cations and the anions. This ability of the halide increases in the order Cl⁻<Br⁻<I⁻, and is initiated by the specific adsorption of the anion onto the metal surface. The greater influence of the iodide ion is often attributed to its large ionic radius, high hydrophobicity, and low electronegativity compared to the other halide ions.

Potassium iodide intensifier can be used in acid systems. Potassium iodide intensifier is effective at bottom hole temperatures (BHTs) up to at least 425° F. (218° C.). It is not compatible with diazonium salts, oxidants, or bromine. When used with an appropriate reducing agent, it will help decrease corrosion rates, additive separation and, sludging, caused by ferric iron.

Preferably, the corrosion inhibitor intensifier is selected from the group consisting of: a source of carboxylate ion selected from the group consisting of formic acid, oxalic acid, sodium formate, potassium formate, sodium oxalate, potassium oxalate, and any combination thereof; a source of iodide ion, wherein the source of iodide ion provides a concentration of iodide ion of at least 0.01 moles/liter in the aqueous phase; a source of cuprous ion, wherein the source of cuprous ion provides a concentration of cuprous ion of at least 0.01 moles/liter in the aqueous phase; and any combination of the foregoing.

Preferably, the source of iodide ion should provide a concentration of iodide ion that is at least about 60 ppt KI in a 70:30 water-in-oil emulsion.

Preferably, the source of cuprous ion should provide a concentration of cuprous ion that is at least about 25 ppt CuCl in a 70:30 water-in-oil emulsion.

Fine particles (<44 microns) of silica gel can also be used as an intensifier. For example, it can be included at in a concentration of at least 10 ppt of the emulsion.

According to a preferred embodiment of the invention, the corrosion inhibitor intensifier is selected from the group consisting of: formic acid and potassium iodide.

The corrosion inhibitor intensifier is preferably in a concentration of at least 0.1% by weight of the emulsion. More preferably, the corrosion inhibitor intensifier is in a concentration in the range of 0.1% to 20% by weight of the emulsion.

### Additives

In various embodiments of the present invention, other components or additives can be included in the treatment fluid provided that they are compatible with all required components and functions of the treatment fluid and do not unduly interfere with its performance. Typical additives that may be included are pH control additives, silicate control additives, emulsion and sludge preventers, and non-emulsifying agents known to those in the field.

For example, the emulsion can contain a freezing-point depressant. Preferably, the freezing point depressant is for the water of the continuous phase. Preferably, the freezing-point depressant is selected from the group consisting of water soluble ionic salts, alcohols, glycols, urea, and any combination thereof in any proportion.

Any additives should be tested for compatibility with the treatment fluid being used.

### Methods

According to an embodiment of the invention, a method of acidizing a treatment zone of a subterranean formation in a well is provided. The method includes the steps of: (A) forming a treatment fluid comprising a composition according to the invention; and (B) introducing the treatment fluid into a well. Advantageously, the design temperature can be at least 280° F. (138° C.). For example, the design temperature can be in the range of about 280° F. (138° C.) to about 400° F., depending on the design time.

According to a preferred embodiment of the method, the subterranean formation to be treated is a carbonate formation.

The treatment fluid may be prepared at the job site, prepared at a plant or facility prior to use, or certain components of the treatment fluid (for example, the continuous liquid phase and the viscosity-increasing agent) may be pre-mixed prior to use and then transported to the job site. Certain components of the treatment fluid may be provided as a “dry mix” to be combined with the continuous liquid phase or other components prior to or during introducing the treatment fluid into the subterranean formation. In certain embodiments, the treatment fluid may be placed into the subterranean formation by placing the treatment fluid into a well bore that penetrates a portion of the subterranean formation.

In certain embodiments (for example, fracturing operations), the treatment fluid may be introduced into the subterranean formation at or above a pressure sufficient to create or enhance one or more fractures in a portion of the subterranean formation. In an embodiment, the step of introducing comprises introducing under conditions for fracturing a treatment zone. The fluid is introduced into the treatment zone at a rate and pressure that are at least sufficient to fracture the zone.

In an embodiment, the step of introducing is at a rate and pressure below the fracture pressure of the treatment zone. In an embodiment, the step of introducing comprises introducing under conditions for gravel packing the treatment zone.

In some embodiments, placing the treatment fluid into the subterranean formation comprises placing the treatment fluid into a well bore penetrating the subterranean formation.

In an embodiment, the treatment fluid is allowed time for spending the acid against the treatment zone, which is also expected to break the emulsion.

In an embodiment, a step of flowing back from the treatment zone is within 24 hours of the step of introducing. In another embodiment, the step of flowing back is within 16 hours of the step of introducing.

Preferably, after any such well treatment, a step of producing hydrocarbon from the subterranean formation is the desirable objective.

### Examples

To facilitate a better understanding of the present invention, the following examples of certain aspects of some embodiments are given. In no way should the following examples be read to limit, or define, the entire scope of the invention.

Procedure for Forming Test Compositions

The oil phase was prepared in a beaker separately from the aqueous phase.

Preferably, the emulsifier is added to oil phase. The emulsifier was mixed with the diesel in a blender jar.

The aqueous phase was prepared in a beaker separately from the oil phase. Preferably, the acid, inhibitor, and one or more intensifiers are added to the aqueous phase.

The aqueous phase was added to the diesel oil phase very slowly with stirring.

Unless specified, a total of 200 ml emulsion with oil-to-aqueous phase ratio of 30:70 (V/V) was prepared for each test in a 500 ml blender jar. Once the addition was completed, the blend was mixed for 4 to 5 minutes keeping the VARIAC™ transformer at 70 and blender mixing speed at “low”. A total of 6 to 7 minutes were used for the entire mixing starting from addition. Immediately after mixing, the blend was transferred to plastic beakers and the blender jar was washed.

Once the blended test composition was prepared, a few drops of it were poured in water to see if they float or sink. Sinking or floating without spreading was considered as sign of formation of an invert emulsion. However, it could not be treated as any indication of stability of the emulsion when treated at high temperature.

Static Corrosion Weight-Loss Test Procedure

For corrosion weight-loss testing, a coupon of casing grade metal alloy material (Low alloy carbon steel) was used, specifically “P110” having the following specifications: chemical composition in %: C: 0.26˜0.35, Si: 0.17˜0.37, Mn: 0.4˜0.7, P: ≦0.02, _S≦0.01, Cr: 0.8˜1.1, Ni: ≦0.2, Cu≦0.2, Mo≦0.15˜0.25, V≦0.08, Al≦0.02, and remaining Fe with mechanical properties as: Tensile strength: ≧862 MPa; Yield Strength: 758˜965 MPa.

Static weight-loss corrosion tests were performed as follows. High pressure, high temperature (“HPHT”) static weight loss corrosion testing was performed in individual HASTELLOY model B-2 autoclaves.

The metal alloy specimens were cleaned by degreasing with acetone followed by removal of the surface scale by lightly bead blasting the surface. Each specimen of approximate surface area 4.4 in² was accurately measured in square inches and accurately weighed in grams. Weighing of the metal specimens (sometimes referred to in the art as “coupons”) was on a balance accurate to 0.001 gram (g).

Test fluids were prepared by mixing the desired components.

Each test fluid was placed into a glass cell, followed by introduction of a metal specimen. After capping the cell, the container with the test fluid and the alloy specimen were placed in the autoclave. The autoclave was filled with a heat transfer medium and pressurized to a test pressure of 1,000 psi with nitrogen gas. Heating was accomplished using EUROTHERM™ controllers that adjust a specific heating ramp up to the test temperature via a computer control. Pressure was maintained using a back pressure regulator assembly which allows for automatic bleed-off of excess pressure developed during heating and corrosion. Test times were contact times and included heat up and cool down times. The test times were the total contact time of the test fluid on the specimen.

At the end of the test time, the alloy test specimen was removed from the test fluid, then cleaned with acetone and a light brushing to remove surface deposits, and finally dried and weighed.

The corrosion loss in units of lb/ft² was calculated using the following equation:

[(Wt.B g−Wt.A g)/(S.A. in²)]*[(144 in²/ft²)/(453.6 g/lb)]=corrosion loss (lb/ft²)

where “S.A. in²” is the surface area of a coupon measured in square inches, “Wt.B” was the weight in grams of the coupon before testing, and where “Wt.A” is the weight in grams of the coupon after testing.

According to this method, the standard for an acceptable corrosion loss for carbon steel is less than or equal to 0.05 lb/ft² under the design conditions of acid and concentration and of fluid contact time at a specified temperature and pressure.

Experimental details, including test fluid compositions, type of metal alloy specimen, and the testing time and temperature, are discussed below.

Emulsion Stability Test Procedure

The emulsion stability was evaluated by visual observation of the emulsified acid blend kept in a measuring cylinder after the corrosion weight-loss test. Any bottom water separation above 5% by volume of the test composition was considered as destabilization.

After the weight loss corrosion tests, the blend was transferred carefully to a glass cylinder and allowed to stay for 5 to 10 minutes so that all bubbles/foams disappear. Then any visual bottom water layer separation was noted for the tests carried out in the visual cell.

Tested Compositions

In general, the tested compositions included an oil phase, an aqueous phase of acidic pH, an emulsifier, and a corrosion inhibitor.

The oil phase used in the tests was diesel.

The aqueous phase was made up with hydrochloric acid (HCl) in the particularly stated percent by weight of the solution. For example, 28% HCl means 28 grams of HCl dissolved in 72 grams water.

The tested emulsions had a ratio of 70% water phase in 30% oil phase by volume.

A conventional emulsifier of the test compositions included about 50% solution of a mixture of monotallow amine acetates (“MTAA”) and ditallow amine acetates (“DTAA”) in a suitable solvent such as heavy aromatic petroleum naphtha and ethylene glycol. The emulsifier was included in each test composition at the particularly stated concentration (gpt) of the total emulsion fluid.

In addition, several compositions according to the invention were tested with an emulsifier consisting essentially of PIBA (5.5 gpt) and MTA (29 ppt).

The test compositions all included a corrosion inhibitor containing 1-(benzyl) quinolinium chloride and cinnamaldehyde in a solvent mixture of isopropanol and methanol. The corrosion inhibitor was included in each test composition at the particularly stated concentration (gpt) of the total emulsion.

The test compositions included corrosion inhibitor intensifiers, specifically formic acid (94-96% aqueous) and a source of iodide ion, specifically potassium iodide (KI). In addition, several of the test compositions also included a source of cuprous ion, specifically cuprous chloride (CuCl), each at the stated concentrations of the total emulsion fluid.

Without being limited by any theory, formic acid is believed to act by reacting with HCl to release carbon monoxide (gas), which attaches to the metal surface, potassium iodide is believed to act by enhancing passivating film formation, and cuprous chloride is believed to act by itself undergoing preferential oxidation over metal surface.

The solubility of formic acid in water is infinite, meaning it is completely miscible with water. Formic acid has a reported density of 1.22 g/ml. The molecular weight of formic acid is 46.0 g/mole.

The solubility of potassium iodide in water is extremely high, reported to be 140 g/100 ml (which is 1400 g/1 or 11,680 ppt) at 75° F. (20° C.), and it is also highly soluble in concentrated HCl. The molecular weight of potassium iodide is 166.0 g/mole.

The solubility of cuprous chloride in water is very low (insoluble), reported to be only 0.0062 g/100 ml (which is 0.062 g/1 or 0.52 ppt) at 75° F. (20° C.); however, it is commonly reported to be soluble in concentrated HCl (although not exactly to what extent).

Testing Results

The use of KEROCOM™ PIBA 03 and monotallow amine (“MTA”) composition as an emulsifier gave good emulsification of the oil and acid phase.

The emulsified acid system containing KEROCOM™ PIBA 03 and monotallow amine (“MTA”) composition as the emulsifier was stable and passed the corrosion test at 300° F. for 6 hours (Table 1). The emulsified acid system with 28% acid strength also passed the corrosion test at 325° F. for 3 hours. The emulsified acid system also passed the corrosion test at 350° F. for 2 hours with 20% acid strength.

TABLE 1
Corrosion tests for emulsified 28% acid system using P-110.

| | | Acid | | Corrosion | formic | | Corrosion | |
|---|---|---|---|---|---|---|---|---|
| Temp. | Time | strength | Emulsifier | Inhibitor | acid | | Loss | Emulsion |
| (° F.) | (hrs) | (HCl) | (gpt or ppt) | (gpt) | (gpt) | Other | (lb/ft2) | stability |
| 300 | 3 | 28% | Formulated | 8 | 5 | KI | 0.041 | Stable |
| | | | emulsifier | | | (60 | | |
| | | | containing | | | ppt) | | |
| | | | MTAA, | | | CuCl | | |
| | | | DTAA, | | | (40 | | |
| | | | Heavy | | | ppt) | | |
| | | | aromatic | | | | | |
| | | | petroleum | | | | | |
| | | | naphtha, | | | | | |
| | | | ethylene | | | | | |
| | | | glycol, | | | | | |
| | | | Acetic acid | | | | | |
| 300 | 3 | 28% | PIBA (5.5 | 8 | 5 | KI | 0.026 | Stable |
| | | | gpt) | | | (60 | | |
| | | | MTA (29 | | | ppt) | | |
| | | | ppt) | | | CuCl | | |
| | | | | | | (40 | | |
| | | | | | | ppt) | | |
| 300 | 3 | 28% | PIBA (5.5 | 8 | 5 | KI | 0.041 | Stable |
| | | | gpt) | | | (60 | | |
| | | | MTA (29 | | | ppt) | | |
| | | | ppt) | | | | | |
| 300 | 4 | 28% | PIBA (5.5 | 8 | 5 | KI | 0.025 | Stable |
| | | | gpt) | | | (80 | | |
| | | | MTA (29 | | | ppt) | | |
| | | | ppt) | | | CuCl | | |
| | | | | | | (25 | | |
| | | | | | | ppt) | | |
| 300 | 6 | 28% | PIBA (5.5 | 8 | 5 | KI | 0.054 | Stable |
| | | | gpt) | | | (80 | | |
| | | | MTA (29 | | | ppt) | | |
| | | | ppt) | | | CuCl | | |
| | | | | | | (25 | | |
| | | | | | | ppt) | | |
| 325 | 2 | 28% | PIBA (5.5 | 8 | 5 | KI | 0.023 | Stable |
| | | | gpt) | | | (80 | | |
| | | | MTA (29 | | | ppt) | | |
| | | | ppt) | | | CuCl | | |
| | | | | | | (25 | | |
| | | | | | | ppt) | | |
| 325 | 3 | 28% | PIBA (5.5 | 8 | 5 | KI | 0.052 | Stable |
| | | | gpt) | | | (80 | | |
| | | | MTA (29 | | | ppt) | | |
| | | | ppt) | | | CuCl | | |
| | | | | | | (25 | | |
| | | | | | | ppt) | | |
| 350 | 2 | 20% | PIBA (5.5 | 8 | 5 | KI | 0.051 | Stable |
| | | | gpt) | | | (80 | | |
| | | | MTA (29 | | | ppt) | | |
| | | | ppt) | | | CuCl | | |
| | | | | | | (25 | | |
| | | | | | | ppt) | | |

Environmental performance of KEROCOM™ PIBA 03 and tallow amine composition: The primary amines are known to be more environmentally friendly than the secondary amines. The secondary amines tend to form nitrosamines in small amount on storage (Chalis B. C. and Kyrtopoylos S. A. (1976) Brit. J. Cancer, 35, 693-696). These nitrosamines are known to be carcinogenic and show bioaccumulation in nature. KEROCOM™ PIBA being a primary amine is expected to be more environmentally friendly than the ditallowamine which is a secondary amine.

In addition, the environmentally friendly nature of the KEROCOM™ PIBA and monotallowamine composition is reflected in its low Chemistry Scoring Index (CSI) as compared to the CSI value of the current emulsifier. (Table 2).

TABLE 2
Chemistry Scoring Index (CSI) of Emulsifiers

| | Environment | Physical | Health | Total |
|---|---|---|---|---|
| | al Hazards | Hazards | Hazards | Product |
| Product Name | Score | Score | Score | Score |
| Formulated emulsifier con- | 440 | 65 | 271 | 776 |
| taining monotallow amine, | | | | |
| ditallow amine, naphthalene, | | | | |
| ethylene glycol. | | | | |
| KEROCOM ™ PIBA 03 | 175 | 10 | 95 | 280 |
| monotallow amine | 150 | 0 | 35 | 185 |
| New emulsifiers* | 164 | 6 | 69 | 239 |
| (KEROCOM ™ PIBA 03 + | | | | |
| monotallow amine) | | | | |

*calculated based on the weighted average

As demonstrated by the examples, the new emulsified acid system with the branched emulsifier can be stable at 300° F. for 6 hours with corrosion loss of only 0.054 lb/ft2 using P-110 coupons. The same system can be used at 325° F. for 3 hours with corrosion loss of only 0.052 lb/ft² using P-110 coupons.

In addition, the new emulsifier composition is environmentally friendly with CSI rating Score of 239.

The new emulsifier is required in lesser quantity as compared to formulated emulsifier containing monotallow amine, ditallow amine, naphthalene, and ethylene glycol. The temperature limit is extended to 325° F. for 3 hours, which is not possible with the current emulsifier. The new emulsified acid system meets the current market demand for acidizing operations at higher temperature up to at least about 350° F.

The emulsion compositions according to the invention are expected to provide one or more benefits, including without limitation: (a) slower acid spending rate resulting in efficient stimulation of oil well, including, for example, better acid wormholing profiles due to slower acid spending rate; (b) improved corrosion inhibition; (c) stabilizing the emulsion for more than 2 to 3 hours at high temperatures of 280° F. (138° C.) and above; (e) significant reduction in corrosion loss due to stable emulsion, especially at 300° F. and above for 3 hours; (f) more efficient oil well stimulations using higher concentration of acid; (g) better stimulation, hence higher production due to slower acid reaction rate; and (h) usefulness in the wells with high design temperatures where existing emulsified acid systems cannot work, thereby expanding the application temperature range of the current formulation.

### CONCLUSION

Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

It will be appreciated that one or more of the above embodiments may be combined with one or more of the other embodiments, unless explicitly stated otherwise.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

1. A method of acidizing a treatment zone of a subterranean formation penetrated by a wellbore of a well, the method comprising the steps of:
(A) forming a treatment fluid in the form of an emulsion, the treatment fluid comprising:
(i) a continuous oil phase;
(ii) an internal aqueous phase adjacent the continuous oil phase, wherein the aqueous phase has a pH of less than one; and
(iii) a source of ammonium ion, wherein the ammonium ion has:
(a) at least 1 ammonium ion;
(b) an organic group with at least 40 carbon atoms;
(c) at least 40 carbon atoms per ammonium ion;
(d) a carbon to nitrogen ratio of at least 20 carbon atoms per nitrogen atom; and
(e) at least one alkyl branch on the organic group; and
(B) introducing the treatment fluid into the well.

2. The method according to claim 1, wherein the ratio of water phase to oil phase is in the range of 50:50 v/v to 80:20 v/v.

3. The method according to claim 1, wherein the continuous oil phase comprises kerosene, diesel oils, crude oils, gas oils, fuel oils, paraffin oils, mineral oils, low toxicity mineral oils, other petroleum distillates, and any combination thereof.

4. The method according to claim 1, wherein the continuous oil phase has a viscosity less than 200 cP.

5. The method according to claim 1, wherein the internal aqueous phase has a pH of less than zero.

6. The method according to claim 1, wherein the internal aqueous phase comprises at least 10% hydrochloric acid by weight of the water.

7. The method according to claim 1, wherein the source of ammonium ion has the properties of being: (a) oil soluble; and (b) water-insoluble.

8. The method according to claim 1, additionally comprising a monotallow amine or a monotallow amine acetate.

9. The method according to claim 1, wherein the treatment fluid additionally comprises: a corrosion inhibitor.

10. The method according to claim 9, wherein the corrosion inhibitor comprises a quaternary ammonium salt with the nitrogen of the ammonium group attached to 4 carbons and being part of an aromatic ring, and any combination thereof.

11. The method according to claim 9, wherein the corrosion inhibitor is selected from the group consisting of: 1-(benzyl) quinolinium chloride, cinnamaldehyde, propargyl alcohol, and any combination thereof.

12. The method according to claim 9, wherein the treatment fluid additionally comprises a corrosion inhibitor intensifier selected from the group consisting of:
a source of carboxylate ion selected from the group consisting of formic acid, oxalic acid, sodium formate, potassium formate, sodium oxalate, potassium oxalate, and any combination thereof;
a source of iodide ion, wherein the source of iodide ion provides a concentration of iodide ion of at least 0.01 moles/liter in the aqueous phase;
a source of cuprous ion, wherein the source of cuprous ion provides a concentration of cuprous ion of at least 0.01 moles/liter in the aqueous phase; and
any combination of the foregoing.

13. The method according to claim 12, wherein, when the treatment fluid is tested at 300° F. for 3 hours, the emulsion is stable and for a P-110 coupon has a corrosion loss of less than about 0.05 lb/ft².

14. The method according to claim 1, wherein the subterranean formation is a carbonate formation.

15. The method according to claim 1, wherein the design temperature is at least 280° F. (138° C.).

16. A composition comprising:
(i) a continuous oil phase;
(ii) an internal aqueous phase adjacent the continuous oil phase, wherein the aqueous phase has a pH of less than one; and
(iii) a source of ammonium ion, wherein the ammonium ion has:
(a) at least 1 ammonium ion;
(b) an organic group with at least 40 carbon atoms;
(c) at least 40 carbon atoms per ammonium ion;
(d) a carbon to nitrogen ratio of at least 20 carbon atoms per nitrogen atom; and
(e) at least one alkyl branch on the organic group.

17. The composition according to claim 16, wherein the source of ammonium ion has the properties of being: (a) oil soluble; and (b) water-insoluble.

18. The composition according to claim 16, additionally comprising a monotallow amine or a monotallow amine acetate.

19. The composition according to claim 16, additionally comprising: a corrosion inhibitor.

20. The composition according to claim 19, additionally comprising a corrosion inhibitor intensifier selected from the group consisting of:
a source of carboxylate ion selected from the group consisting of formic acid, oxalic acid, sodium formate, potassium formate, sodium oxalate, potassium oxalate, and any combination thereof;
a source of iodide ion, wherein the source of iodide ion provides a concentration of iodide ion of at least 0.01 moles/liter in the aqueous phase;
a source of cuprous ion, wherein the source of cuprous ion provides a concentration of cuprous ion of at least 0.01 moles/liter in the aqueous phase; and
any combination of the foregoing.
